(19) United States
(12) Patent Application Publication
(10) Pub. No.: US 2012/0254048 A1
(43) Pub. Date: Oct. 4, 2012

(54) SYSTEM AND METHOD FOR REGULATORY SECURITY COMPLIANCE MANAGEMENT

(75) Inventors: Steven E. ROBERTS, Houston, TX (US); Daniel L. SLATON, Houston, TX (US); William C. MONTGOMERY, Spring, TX (US); Syed AZIM, Katy, TX (US); Leslie M. SCHULMAN, Wichita, KS (US)

(73) Assignee: CHEMSECURE LLC, Houston, TX (US)

(21) Appl. No.: 13/075,919

(22) Filed: Mar. 30, 2011

(51) Int. Cl. G06Q 99/00

(52) U.S. Cl. 705/317

(57) ABSTRACT

A system and method for managing regulatory security compliance at facilities regulated by the Chemical Facility Anti-Terrorism Standards (CFATS). In one embodiment, a method includes storing security records related to the facility in a security documentation storage system. Compliance fields of the security records are identified. The compliance fields contain information related to compliance with a security standard applied to the facility. The information is compared to predetermined values indicative of compliance with the security standard. An indicator signifying whether the facility is in compliance with the security standard is generated. The state of the indicator is based on a result of the comparing.

### BACKGROUND

Facilities that manufacture, use, store, or distribute chemicals that are considered to present a safety risk are subject to various regulations. Chemical facilities that present a high risk to public safety in the event of a terrorist attack are subject to regulation by the Department of Homeland Security (DHS) under the Chemical Facility Anti-Terrorism Standards (CFATS). More specifically, chemical facilities that possess greater than a threshold amount of any Chemical of Interest (COI) are subject to regulation under CFATS. A COI is a chemical determined by DHS to present a security issue. CFATS requires facilities that possess one or more COIs at or above the threshold to submit facility-related information to DHS through a process known as the Top-Screen. After review of the Top-Screen, DHS makes a preliminary “high-risk” determination. Preliminary “high-risk” facilities are then required to conduct a Security Vulnerability Assessment (SVA).

The SVA requires the facility to assess the consequences of a series of attack scenarios applied to facility assets associated with each COI, and to assess the effectiveness of the facility's planned response to each attack. If, based on the SVA, a facility's “high-risk” status is confirmed by DHS, the facility is required to develop a Site Security Plan (SSP). The SSP must address eighteen security parameters identified as the Risk-Based Performance Standards (RBPSs) of CFATS. For example, perimeter security, asset security, sabotage deterrence, facility monitoring, etc. must be addressed. No specific security measures are mandated. The facility may implement any security measures that meet the RBPSs.

Once the SSP is approved by DHS, the facility is required to ensure ongoing compliance with its SSP. On-site inspections are conducted to verify the facility's compliance with the SSP. Facilities must have the ability to produce all required regulatory records as well as demonstrate compliance with the policies, procedures, and physical security measures described in the SSP. Compliance violations can result in fines and/or closure of the facility.

### SUMMARY

A system and method for managing CFATS regulatory security compliance of a facility. In one embodiment, a security compliance management system includes a processor, a security documentation storage system, and a security compliance monitoring module. The security documentation storage system is coupled to the processor. The security compliance monitoring module configures the processor to examine security records stored in the security documentation storage system, and identify compliance fields of the security records. The compliance fields contain information related to compliance of a facility with a security standard to which the facility is subject. The security compliance monitoring module also configures the processor to compare the information to predetermined values indicative of compliance with the security standard, and generate an indicator signifying whether the facility is compliant with the security standard. The state of the indicator is based on the comparison of the information to the predetermined values.

In another embodiment, a method includes storing security records related to the facility in a security documentation storage system. Compliance fields of the security records are identified. The compliance fields contain information related to compliance with a security standard applied to the facility. The information is compared to predetermined values indicative of compliance with the security standard. An indicator signifying whether the facility is in compliance with the security standard is generated. The state of the indicator is based on a result of the comparing.

In a further embodiment, a computer-readable medium is encoded with instructions that when executed cause a processor to examine security records stored in a security documentation storage system, and identify compliance fields of the security records. The compliance fields containing information related to compliance of a chemical facility with a security standard to which the facility is subject. The instructions also cause the processor to compare the information to predetermined values indicative of compliance with the security standard, and generate an indicator signifying whether the facility is in compliance with the security standard. The state of the indicator is based on the comparison of the information to the predetermined values.

### BRIEF DESCRIPTION OF THE DRAWINGS

For a detailed description of exemplary embodiments of the invention, reference will now be made to the accompanying drawings in which:

FIG. 1 shows a block diagram of a security compliance management system in accordance with various embodiments;

FIG. 2 shows a block diagram of security compliance management modules in accordance with various embodiments;

FIG. 3 shows a block diagram of security compliance records in accordance with various embodiments;

FIG. 4 shows a flow diagram for a method for monitoring security compliance in accordance with various embodiments;

FIG. 5 shows a flow diagram for a method for determining security compliance based on an employee security training record in accordance with various embodiments;

FIG. 6 shows a flow diagram for a method for determining security compliance based on an employee background check record in accordance with various embodiments;

FIG. 7 shows a flow diagram for a method for determining security compliance based on a security equipment operability record in accordance with various embodiments;

FIG. 8 shows a flow diagram for a method for determining security compliance based on an employee authentication field of a security record in accordance with various embodiments;

FIG. 9 shows a flow diagram for a method for facilitating security compliance management in accordance with various embodiments;

FIG. 10 shows a facility selection dialog generated by a security compliance management system in accordance with various embodiments;

FIG. 11 shows a facility specific security record management dialog generated by a security compliance management system in accordance with various embodiments;

FIG. 12 shows an equipment operability status dialog generated by a security compliance management system in accordance with various embodiments;

FIG. 13 shows an employee security training dialog generated by a security compliance management system in accordance with various embodiments;

FIG. 14 shows an employee background check dialog generated by a security compliance management system in accordance with various embodiments;

FIG. 15 shows a facility alert dialog generated by a security compliance management system in accordance with various embodiments;

FIG. 16 shows an facility alert history dialog generated by a security compliance management system in accordance with various embodiments;

FIG. 17 shows a multi-facility compliance map generated by a security compliance management system in accordance with various embodiments;

FIG. 18 shows a security compliance management database of a security compliance management system in accordance with various embodiments;

FIG. 19 shows an audit record entry dialog generated by a security compliance management system in accordance with various embodiments; and

FIG. 20 shows an audit report dialog generated by the security compliance management system in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The penalties imposed for failure to comply with a security regulation, such as the Chemical Facility Anti-Terrorism Standards (CFATS), can be severe. Site Security Plans (SSPs) developed in accordance with the regulation can be extremely complex, and can vary from facility to facility. Consequently, the numerous actions that must be performed and the documentation that must be generated and maintained to establish compliance with the regulation, and specifically the SSP, can be burdensome. Thus, while entities may desire to comply with the regulation, compliance may nonetheless be difficult to ensure. Embodiments of the present disclosure simplify management of security compliance by organizing security information and monitoring the security information for indications of non-compliance with the regulation. Thus, the security compliance management systems disclosed herein facilitate compliance with complex security regulations applied to facilities housing potentially dangerous substances, such as Chemicals of Interest (COIs) regulated under CFATS.

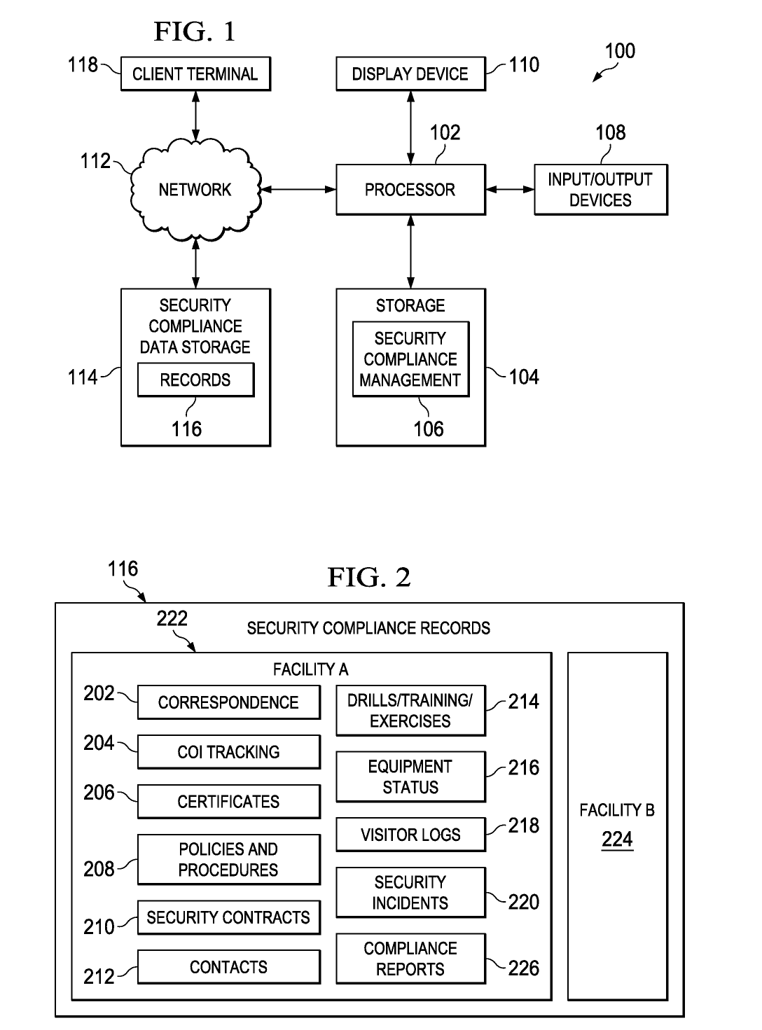

FIG. 1 shows a block diagram of a security compliance management system 100 in accordance with various embodiments. The system 100 includes a processor 102, storage 106, a display device 110, an input/output device 108, and security compliance data storage 114. At least some components of the system 100, for example the processor 102 and the storage 106, can be embodied in any of various computer-based devices, such as a desktop computer, a notebook computer, a tablet computer, a workstation computer, a server computer, a blade computer, etc.

The processor 102 can include one or more processing units or processor cores configured to execute instructions retrieved from the storage 104. The processor 102 may be implemented as one or more microprocessors, microcomputers, microcontrollers, digital signal processors, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The display device 110 is a device configured to represent information visually. The display device 100 may output video, graphical, and/or textual information. Exemplary display devices 110 include liquid crystal displays, cathode ray displays, plasma displays, organic light emitting diode displays, vacuum fluorescent displays, electroluminescent displays, electronic paper displays, or other display panel technologies suitable for providing information generated by the processor 102 to a user.

The input/output devices 108 provide an interface for entry of information and control to the processor 102, and/or for output of information from the processor 102. Exemplary input devices suitable for providing user input to the processor 102 include keyboards and pointing devices (e.g., a mouse, trackball, light pen, touch pad, touch screen, motion sensor, etc.). Some such devices may be coupled to the processor 102 via wired or wireless communications subsystems, such as Universal Serial Bus, Bluetooth, etc.

The storage 104 is a computer-readable medium that is coupled to and accessed by the processor 202. The storage 204 may be volatile or non-volatile semiconductor memory (e.g., FLASH memory, static or dynamic random access memory, etc.), magnetic storage (e.g., a hard drive, tape, etc.), optical storage (e.g., compact disc, digital versatile disc, etc.), etc. The storage 104 is suitable for storing instructions to be executed by the processor 102. The security compliance management module 106 includes instructions that when executed cause the processor 102 to perform the security compliance management system operations disclosed herein.

Those skilled in the art understand that software (i.e., instructions executable by a processor) is incapable of performing any operation in and of itself, but rather software when executed configures the processor to perform an operation. Therefore, an operation described herein as performed by software is simply a shorthand notation for describing a processor performing the operation by execution of suitable software.

The security compliance data storage 114 is a data storage device configured to store security compliance information, such as security records 116. The security compliance data storage 114 includes a computer-readable medium as described above. In some embodiments, the security compliance data storage 114 includes a database (e.g., an object-oriented or relational database) for storing the security records 116.

In some embodiments of the system 100, the security compliance data storage 114 is local to the processor 102 (e.g., residing in the same computer housing as the processor 102). In other embodiments, the security compliance data storage 114 is remote from the processor 102. In such embodiments, the processor 102 may access the security compliance data storage 104 via a network 112, and a network adapter (not shown) coupled to the processor 102. The network 112 may comprise any available computer networking arrangement, for example, a local area network (“LAN”), a wide area network (“WAN”), a metropolitan area network (“MAN”), the internet, etc. Further, the network 112 may comprise any of a variety of networking technologies, for example, wired, wireless, or optical techniques may be employed. Accordingly, the processor 102 and the security compliance data storage 104 are not restricted to any particular location or proximity to one another.

The security compliance management module 106 manipulates (i.e., configures the processor 102 to manipulate) the security records 116 stored in the security compliance data storage 114. More specifically, the security compliance management module 106 provides for entry of security records 116, organizing of security records 116, monitoring of security records 116, and display of security records 116 or information derived from security records 116.

In some embodiments of the system 100, the processor 102 and the storage 104 are part of a server (e.g., a web server) that provides security management data and functionality through a client terminal 118 coupled to the server via the network 118. The client terminal 118 may provide a user interface to the security compliance management system 100 via, for example, a web browser executing on the client terminal 118. The client terminal 118 may include a processor, display device, and input/output device similar to the processor 102, display device 110, and input/output devices 108 described herein.

FIG. 2 shows a block diagram of the various documents and records included in the security compliance records 116 in accordance with various embodiments. The security compliance records 116 may be organized according to one or more facilities to which the records apply. In the example of FIG. 2, the security compliance records 116 include security records for two facilities, Facility A 222 and Facility B 224. It is understood that the security compliance records 116 may include security records for any number of facilities. For example, the security compliance records 116 may include security records for all chemical facilities owned or controlled by an entity (e.g., a corporation).

For each facility, the security compliance records 116 include documents and records related to the applicable security regulation (e.g., CFATS) and compliance with the regulation by the facility. One embodiment of stored security compliance records for Facility A 222 includes Correspondence records 202, Contacts records 212, Certificates 206, Policies and Procedures records 208, Security Contracts records 210, Drills/Training/Exercises records 214, Chemical of Interest Tracking records 204, Security Incidents records 220, Equipment Status records 216, Visitor Logs 218, and Compliance Reports 226. Other embodiments may include a different number and/or different types of security records.

Each of the records discussed are with reference to Facility A. A different set of records may be stored for each facility. The Correspondence records 202 include copies of security related correspondence, such as correspondence with a regulatory agency (e.g., the Department of Homeland Security) relating to the Facility A. The Contacts records 212 include contact information (e.g., telephone numbers, addresses, email addresses, etc.) for users of the security compliance management system 110 and various security and entity related parties and personnel (e.g., a party to contact in the event of a security incident or emergency situation) relevant to the Facility A.

The Certificates 206 include documents attesting to completion of training for use of the Security Compliance Management System 100 by individuals connected to the Facility A. The Policies and Procedures records 208 include documents specifying how a security plan for Facility A is to be implemented. For example, the Policies and Procedures records 208 may detail the means and methods by which a CFATS site security plan (SSP) for the Facility A is to be implemented. The Security Contracts 210 may include copies of security related agreements between the entity controlling the Facility A and other entities (e.g., a security system installation and maintenance contract).

The Drills/Training/Exercises records 214 include records of security drills and exercises performed at the Facility A, and records of security training provided to employees of the Facility A. Chemical of Interest Tracking records 204 include documentation detailing the types, quantities, and locations of chemicals of interest (COI) at the Facility A at a given time. Security Incidents records 220 include documentation related to events occurring at the Facility A that involve security. For example, a record of unauthorized personnel detected in the Facility A, or a discrepancy in quantity of a COI.

Equipment Status records 216 include documentation related to the maintenance, repair, or operability status of security equipment installed in the Facility A. For example, in the event of an equipment (e.g., a video camera) failure or malfunction, a record 216 may identify the equipment, its location, and the nature of the failure or the operational status of the equipment. The visitor logs 218 record information concerning visitors to the Facility A, such information may include visitor identity, time on site, purpose of visit, employees contacted during the visit, etc.

Compliance Reports 226 include records (audit records) documenting whether the facility, or at least some aspect of the facility, is in compliance with the facility security plan (e.g., the SSP) at a given point in time. Each audit record stored in the Compliance Reports 226 may include information detailing whether security measures, procedures, and policies specified in the SSP are in place and/or are in practice at the time the record is entered. In some embodiments, facility personnel are expected to enter an audit record on a periodic (e.g., daily) basis.

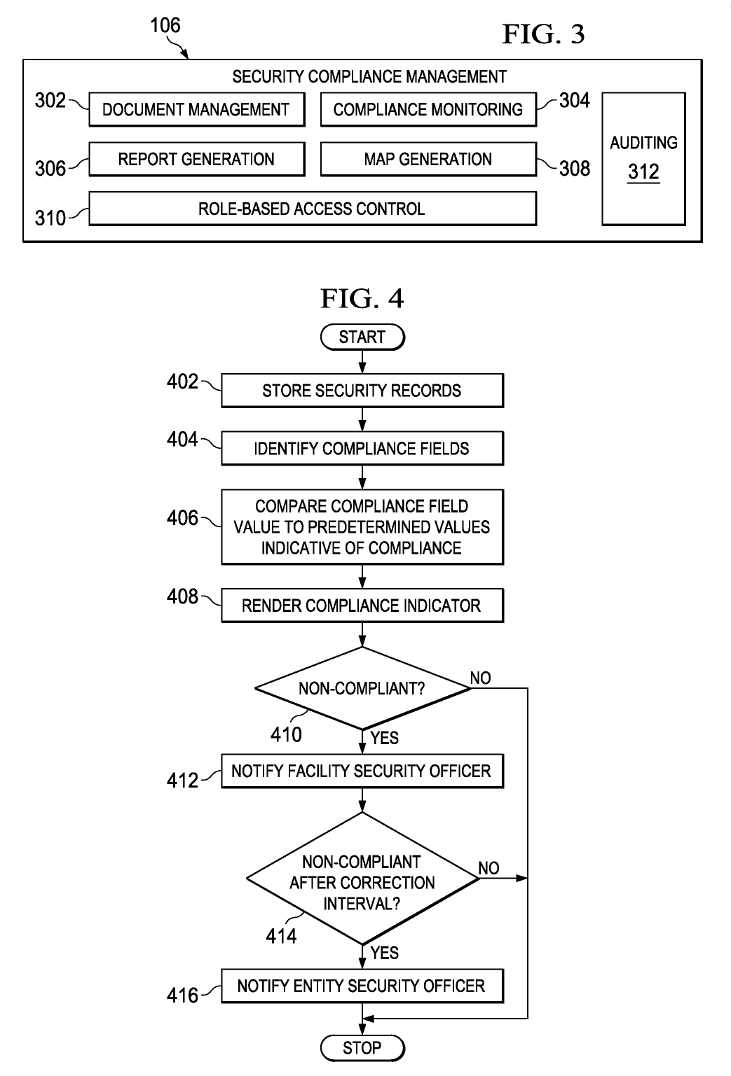

The security compliance management system 100 organizes and controls access to the contents of the security compliance records 116, and monitors the records 116 for indications of whether the facility is compliant with an applicable security standard. FIG. 3 shows a block diagram of components of the security compliance management module 106. The components include a role-based access control module 310, document management module 302, a compliance monitoring module 304, a report generation module 306, and a map generation module 308. The role-based access control module 310 provides access to the features of the security compliance management system 100 and the records stored therein based on a role of a user accessing the system 100. A user's role and corresponding access privileges are identified when the user is enrolled with the system 100. For example, a first level of user may have access to the system 100 only for viewing security records. A second level of user may have record viewing privileges and record entry privileges with regard to specified records. A third level of user (e.g., an official responsible for security of a facility, i.e., a Facility Security Officer (FSO)) may have full access to all documents related to a facility for all purposes. A fourth level of user (e.g., an official responsible for security of all facilities controlled by an entity, i.e., a Corporate Security Officer (CSO)) may have full access to all documents related to any facility controlled by an entity. The role-based access control module 310 can interface with the modules 302-308 to enable suitable role-based functionality of each module 302-308 (e.g., reports generated based on role).

The document management module 302 can add a facility to the security compliance records 116, and manipulate documents and records linked to the facility (e.g., add, modify, delete, and/or display documents and records). The document management module 302 may provide dialogs through which the various fields of a security record are entered and/or modified, and/or may allow a document to be imported in whole. For example, an equipment status dialog may allow for record entry and or modification by providing fields that prompt for entry of equipment and status information, while a copy of security contract may be imported in whole. The document management module 302 may present lists of records available for display or manipulation based on user role and record category.

The report generation module 306 extracts information from the security compliance records 116, processes the information, and generates reports therefrom. One type of report generated by the report generation module 306 may show a record of a facility's compliance with a security regulation over time. Another type of report may show details of a particular type of compliance record over time, or may any other statistical organization of records. For example, equipment failures by type of equipment or area of a facility may be reported. The types of reports generated are further based on a role of the user requesting the report. For example, an FSO may request generation of reports related only to a facility with which the FSO is associated, while a CSO may request generation of reports related to all facilities controlled by the entity.

The map generation module 308 produces graphic representations of a facility that show the location of chemicals of interest and security equipment and/or security assets (e.g., chemical handling equipment) within the facility. The map generation module 308 may provide various view of the facility, such as a ground view, a bird's eye view, etc. with zooming and identification of chemicals and assets. The map generation module 308 can provide additional information regarding chemicals and assets when a user positions a cursor at the location of the chemical or asset.

The map generation module 308 may produce different maps based on a role of the user requesting the map. For example, a CSO may obtain a map showing all facilities controlled by the corporate entity and the compliance status of each facility, and may zoom into a selected facility showing all available security details of the selected facility including the compliance status of security assets. A FSO may obtain a map showing a facility with which the FSO is associated, and the map may show all available security details of the facility including the compliance status of facility and security assets. Other users may obtain maps showing a single facility or portion of a facility with which the user is linked. For example, a user responsible for security equipment may obtain a map of facility showing security equipment and equipment status, but not showing chemical locations or status of other security assets.

The compliance monitoring module 304 parses the stored security compliance records 116, and based on the contents of the security records determines whether the facility associated with the security records is in compliance with the applicable security standard. The compliance monitoring module 304 renders a graphical security compliance indicator on the display device 110 and or the client terminal 118. In some embodiments, the graphical security compliance indicator signifies whether the facility is in compliance, potentially out of compliance, or out of compliance. For example, a first state of the indicator (e.g., indicator colored green) may indicate facility compliance with a security regulation, a second state of the indicator (e.g., indicator colored yellow) may indicate potential facility non-compliance with the security regulation, and a third state of the indicator (e.g., indicator colored red) may indicate facility non-compliance with the security regulation. In some embodiments, the compliance monitoring module 304 changes the state of the indicator from potentially non-compliant to non-compliant based on failure to correct a condition (as reflected in the records 116) triggering the potential non-compliance within a predetermined interval of time after detection of the condition.

In conjunction with rendering the compliance indicator, the compliance monitoring module 304 may generate and distribute notification messages (e.g., emails, SMS messages, etc.) if the facility is non-compliant or potentially non-compliant with a security standard. In some embodiments, the compliance monitoring module 304 sends a message to a first level security official (e.g., an FSO) when potential non-compliance is detected, and sends a message to a second (higher) level security official (e.g., a CSO) when a non-compliance is detected (e.g., when potential non-compliance is promoted to non-compliance). The message transmitted by the compliance monitoring module may not indicate the nature of the compliance issue, and alternatively may not indicate a compliance issue, but rather may indicate that the user receiving the message should log on to the security compliance management system 100, which will provide the user with further information. In this way, the existence and nature of a detected compliance issue is secured within the system 100 which may require user authentication (user name, password, identity challenges, biometric verification, etc.) for access.

In order to parse the security records for compliance with a security standard, the compliance monitoring module 304 identifies records that include fields that may contain information indicative of non-compliance, reads the information from the fields, and compares the information to a set of predetermined values indicative of compliance. If the comparison of information read from the fields to the set of values indicates non-compliance with the security standard, then the compliance monitoring module 304 may deem the facility non-compliant or potentially non-compliant.

The auditing module 312 monitors entry of records for storage in Compliance Reports 226, provides for entry of such audit records, and aggregates audit records acquired over a time period to generate an audit report detailing facility compliance with its security plan over the time period (e.g., over the last year). Some embodiments of the auditing module 312 require entry of facility audit records on a periodic (e.g., daily) basis. The auditing module 312 may generate an audit record entry dialog tailored to the facility SPP. The dialog prompts for entry of information related to compliance with the facility SSP and produces, based on the entered information, an audit record that is stored in Compliance Reports 226. If the information entered indicates that the facility is not in compliance with the SSP, and therefore not in compliance with the security regulation, then the auditing module 312 may notify a security officer (e.g., an FSO) of the non-compliance.

Some embodiments of the auditing module 312 may notify the security officer if an audit record corresponding to a predetermined time interval has not been entered prior to an entry deadline (e.g., 12 PM of the day following the day corresponding to the audit record). Such embodiments may further generate an indication of non-compliance (e.g., yellow compliance indicator) if the expected audit record has not been entered prior to a second entry deadline (e.g., 48 hours after the security officer is notified of the missing audit record). The auditing module 312 may generate an indication of non-compliance denoting higher urgency (e.g., red compliance indicator) if the expected audit record has not been entered prior to a third entry deadline (e.g., 72 hours after the security officer is notified of the missing audit record). The auditing module 312 may generate the indication of non-compliance in cooperation with the compliance monitoring module 312. For example, the auditing module 312 may provide audit compliance information to the compliance monitoring module 312 that is used to generate a compliance indicator as described herein.

A security regulation may require production of audit reports as evidence of compliance with a security standard. For example, CFATS regulated facilities are required to conduct annual audits with regard to SSP compliance. While requiring an audit, the security regulation may provide little guidance as to how the audit is to be performed. The auditing module 312 generates an audit report detailing facility compliance with its security plan over a time period as required by the security regulation. The auditing module 312 displays dialogs presenting specific questions regarding the facility's compliance with the facility security plan (e.g., the facility SSP). The questions may be organized in accordance with the security parameters addressed by the security plan, and based on metrics indicative of compliance.

With regard to CFATS, the questions are organized according to the Risk-Based Performance Standards (RBPSs), and are based on compliance metrics that the Department of Homeland Security (DHS) has indicated are sufficient for the facility's specific risk tier, where lower tier numbers indicate higher risk (i.e., a tier 1 facility is higher risk than a tier 2 facility). Accordingly, the auditing module 312 may generate the questions based, at least in part, on the risk tier to which the facility is assigned.

The auditing module 312 builds an audit report that includes the questions and the responses to the questions. The auditing module 312 attaches to the audit report all of the compliance records stored in the security compliance records 116 required to show compliance with a record keeping regulation. The audit module 312 may also attach to the audit report stored periodic audit records as evidence of day-to-day compliance with the facility security plan.

FIG. 4 shows a flow diagram for a method for monitoring security compliance in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 4, as well as other operations described herein, can be implemented as instructions stored in a computer readable medium (e.g., storage 104) and executed by the processor 102.

In block 402, the security compliance management system 100 stores, in the security compliance data storage 114, security records related to a facility. The security records may be entered into the system 100 by entering values in fields of a dialog generated by the security compliance management system 100, by having the security compliance monitoring system 100 retrieve a document from a storage device, etc.

In block 404, the security compliance management system 100 identifies records stored in the security compliance data storage 114 that may contain information indicative of a facility's compliance or non-compliance with a security standard. The security compliance management system 100 further identifies specific fields of the identified records that contain such information.

In block 406, the security compliance management system 100 extracts the information from the identified fields and compares the values extracted from the fields to a set of predetermined values. In some embodiments, the predetermined values may be indicative of compliance with the standard. In other embodiments, the predetermined values may be indicative of non-compliance with the standard.

In block 408, the security compliance management system 100 renders a compliance indicator on a display device, e.g., the display device 110. The state of the rendered compliance indicator is determined based on the comparison of the values extracted from the fields to the set of predetermined values. In some embodiments, the compliance indicator has three states: compliant, potentially non-compliant, and non-compliant.

In block 410, if the facility is determined to be potentially non-compliant with the security standard, based on the comparison of the values extracted from the fields to the set of predetermined values, then in block 412, a facility security officer is notified to access the security compliance management system 100. In some embodiments, the facility security officer is notified immediately when non-compliance is detected. In other embodiments, the facility security officer is notified if the non-compliance is not corrected within a predetermined time interval (e.g. four hours) after detection. The security compliance management system 100 provides the facility security officer with information related to the potential non-compliance when the facility security officer accesses the system 100. For example, information regarding the detected non-compliance or information regarding transmitted notification messages may be stored in a log maintained by the security compliance management system 100 for viewing by the security officer. In some embodiments, the security compliance management system 100 may generate records and/or reports identifying detected non-compliant conditions based on type of non-compliance (e.g., equipment operability, employee training, etc.), time of detection, time of correction, length of condition, etc. for viewing by the security officer.

In block 414, the security compliance management system 100 determines whether the potential non-compliance has been corrected within a predetermined correction interval (e.g., 24 hours after detection of non-compliance). If the potential non-compliance has not been corrected within the predetermined correction interval, then in block 416, the potential non-compliance may be promoted to non-compliance with a corresponding change in state of the compliance indicator, and an entity level security officer may be notified to access the security compliance management system 100. The security compliance management system 100 provides the entity security officer with information related to the non-compliance when the entity security officer accesses the system 100 as described above.

In some embodiments, the security compliance management system 100 will periodically transmit a notification to both the facility security officer and the corporate security officer at a predetermined interval (e.g., every 24 hours) until the detected non-compliance is corrected.

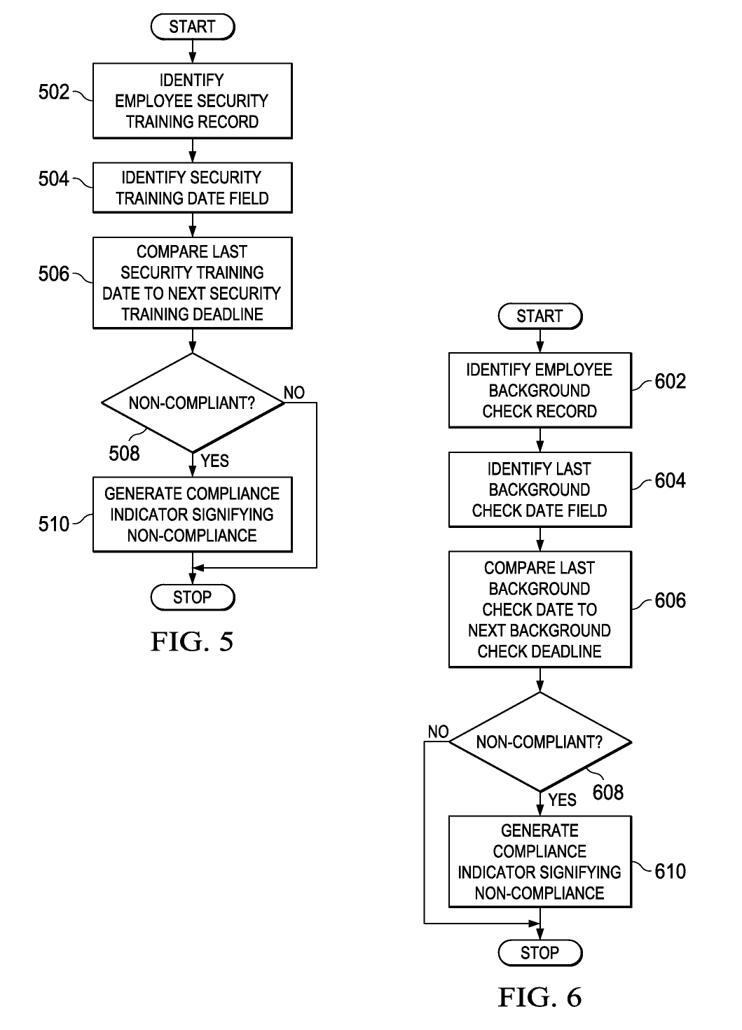

FIG. 5 shows a flow diagram for a method for determining security compliance based on an employee security training record in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 5, as well as other operations described herein, can be implemented as instructions stored in a computer readable medium (e.g., storage 104) and executed by the processor 102.

In block 502, the security compliance management system 100 is parsing the security records stored in the security compliance data storage 114. The security compliance management system 100 identifies an employee security training record. Employee security training records are indicative of compliance and/or non-compliance with a security standard if the standard requires that employees working at a facility receive security training at no less than a prescribed frequency.

In block 504, the security compliance management system 100 identifies a security training date field of the training record. The security training date field contains a value specifying the date on which the employee last received security training. The security compliance management system 100 extracts the last training date from the date field.

In block 506, the security compliance management system 100 compares the last training date to a date by which the employee must receive a next security training for compliance with the security standard.

In block 508, if the time expired since the last training date is greater than a predetermined maximum employee security training interval, then the facility is deemed non-compliant or potentially non-compliant with the security standard, and in block 510, the security compliance management system 100 renders a compliance indicator signifying the non-compliance on a display device (e.g., the display device 110).

FIG. 6 shows a flow diagram for a method for determining security compliance based on an employee background check record in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 6, as well as other operations described herein, can be implemented as instructions stored in a computer readable medium (e.g., storage 104) and executed by the processor 102.

In block 602, the security compliance management system 100 is parsing the security records stored in the security compliance data storage 114. The security compliance management system 100 identifies an employee background check record. Employee background check records are indicative of compliance or non-compliance with a security standard if the standard requires that employees working at a facility undergo background checks at no less than a prescribed frequency.

In block 604, the security compliance management system 100 identifies a background check date field of the background check record. The background check date field contains a value specifying the date on which the employee last underwent a background check. The security compliance management system 100 extracts the last background check date from the date field.

In block 606, the security compliance management system 100 compares the last background check date to a date by which the employee must undergo a next background check for compliance with the security standard.

In block 608, if the time expired since the last background check date is greater than a predetermined maximum inter-background check time interval, then the facility is deemed non-compliant or potentially non-compliant with the security standard, and in block 610, the security compliance management system 100 renders a compliance indicator signifying the non-compliance on a display device (e.g., the display device 110).

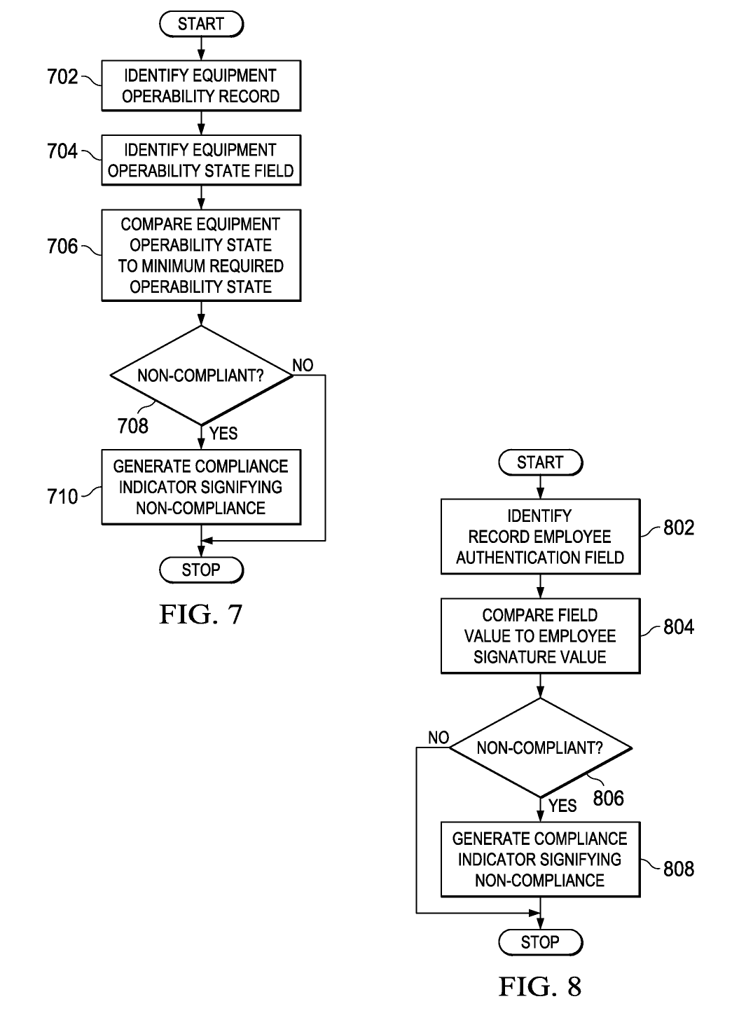

FIG. 7 shows a flow diagram for a method for determining security compliance based on a security equipment operability record in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 7, as well as other operations described herein, can be implemented as instructions stored in a computer readable medium (e.g., storage 104) and executed by the processor 102.

In block 702, the security compliance management system 100 is parsing the security records stored in the security compliance data storage 114. The security compliance management system 100 identifies a security equipment operability record. Security equipment operability records are indicative of compliance or non-compliance with a security standard if the standard requires that areas of a facility (e.g., areas housing COIs) are protected and/or monitored by security equipment, and that security equipment related to area maintain a prescribed degree of operability. For example, if multiple cameras are positioned to monitor an area, the standard may specify that some percentage of the cameras be operable to monitor a specified fraction of the area at all times.

In block 704, the security compliance management system 100 identifies an equipment operability state field of the equipment operability record. The operability state field contains a value specifying the operational state of the subject piece of security equipment. The security compliance management system 100 extracts the last operational state from the state field.

In block 706, in some embodiments, the security compliance management system 100 compares the operational state to a minimum operational state required for the equipment by the security standard. In other embodiments, the security compliance management system 100 accounts for the affect of the operational state on the operational state of a set of equipment comprising the subject equipment. For example, a fraction of area monitored by operational equipment may be determined.

In block 708, if according to the particular embodiment, the operation state of the subject equipment or of the set of equipment comprising the subject equipment is below the minimum required operational state, then the facility is deemed non-compliant or potentially non-compliant with the security standard, and in block 710, the security compliance management system 100 renders a compliance indicator signifying the non-compliance on a display device (e.g., the display device 110).

FIG. 8 shows a flow diagram for a method for determining security compliance based on an employee authentication field of a security record in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 8, as well as other operations described herein, can be implemented as instructions stored in a computer readable medium (e.g., storage 104) and executed by the processor 102.

In block 802, the security compliance management system 100 is parsing the security records stored in the security compliance data storage 114. The security compliance management system 100 identifies a security record that includes an employee authentication field, and identifies the employee authentication field. Information (e.g., an employee signature value) contained in the employee authentication field of the security document validates the contents of the security record. The security compliance management system 100 extracts the information from the authentication field.

In block 804, the security compliance management system 100 compares the information extracted from the authentication field to a stored employee signature value. If the information does not represent an employee signature value, then the facility is found to be non-compliant or potentially non-compliant in block 806.

In block 808, the security compliance management system 100 renders a compliance indicator on a display device (e.g., the display device 110) signifying the detected non-compliance.

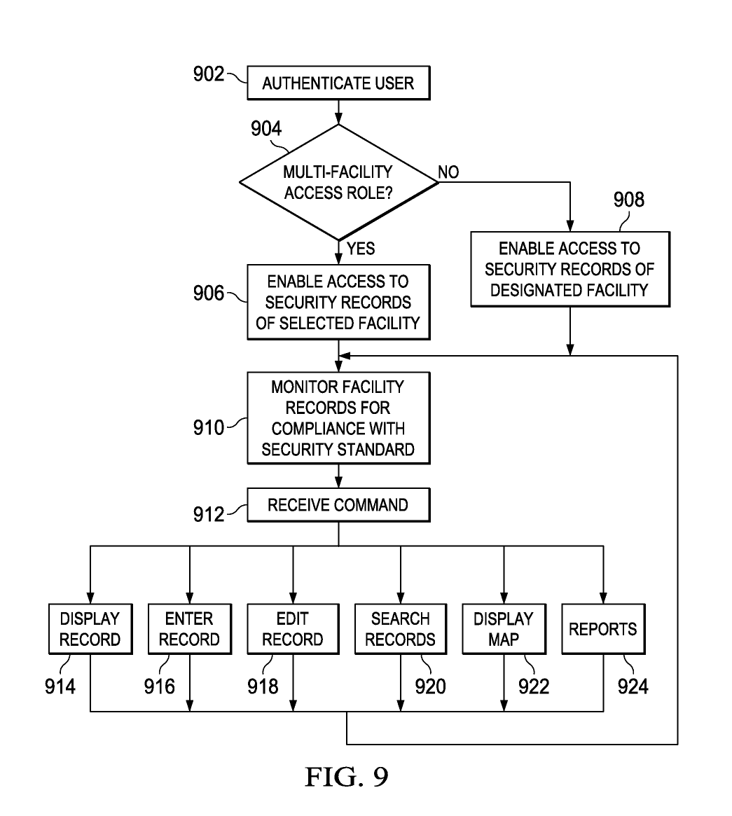

FIG. 9 shows a flow diagram for a method for facilitating security compliance management in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 9, as well as other operations described herein, can be implemented as instructions stored in a computer readable medium (e.g., storage 104) and executed by the processor 102.

In block 902, the security compliance management system 100 authenticates a user that is logging onto the system 100. Authentication may be by user name, password, challenge/response, biometric data, etc. The system 100 may be configured to deny or restrict access to unauthenticated users.

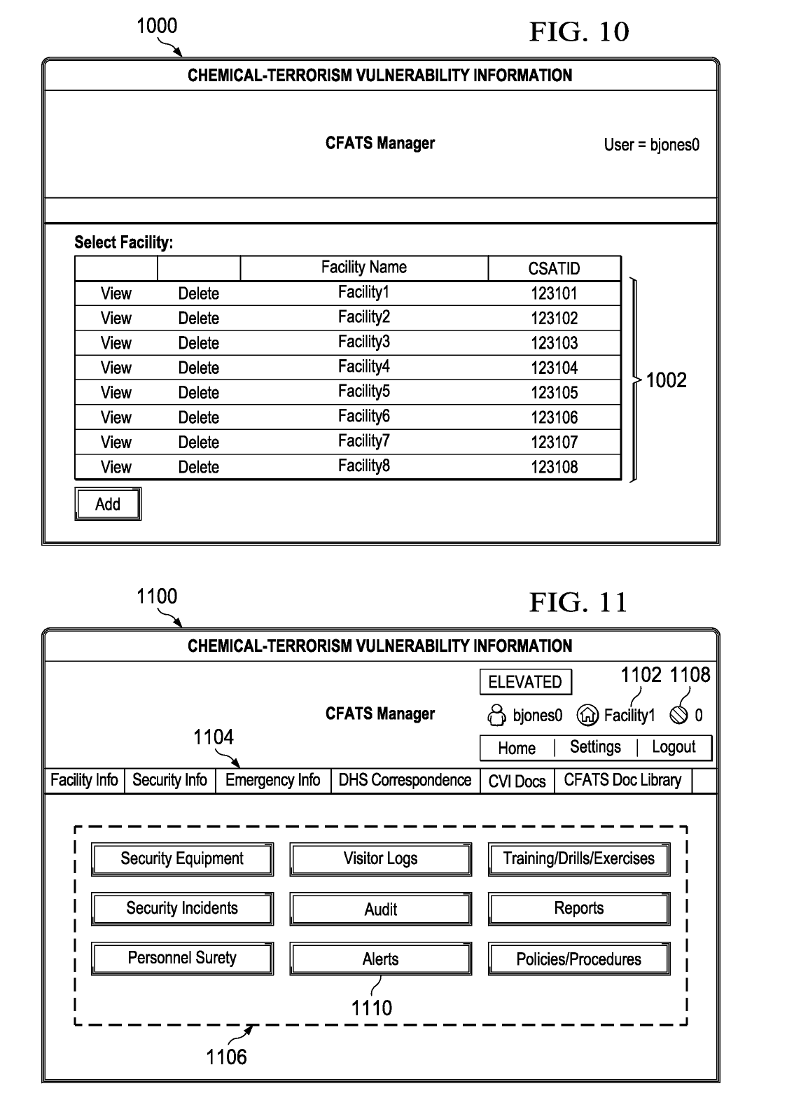

In block 904, the security compliance management system 100 determines, based on the identity of the user and the role of the user (e.g., CSO, FSO, etc.) as previous entered into the system 100 during an enrollment process, whether the user is permitted to access the security records of a multiple facilities. If the user's role permits access to the records of multiple facilities, then in block 906, the user selects a facility from a set of available facilities and the security compliance management system 100 enables the security records of the selected facility for access. FIG. 10 shows a facility selection dialog 1000 generated by the security compliance management system 100. The dialog 1000 allows the multi-facility user to select any of the available facilities 1002 for further access. If, on the other hand, the user's role permits access to only a designated facility, then in block 908, the security compliance management system 100 enables the security records of the designated facility for access. FIG. 11 shows a dialog 1100 generated by the security compliance management system 100 for accessing the security records of a given facility 1102 (Facility 1 in this example). The dialog 1100 includes a menu 1104 and various buttons 1106 for accessing the security records 116 associated with the facility 1102.

In block 910, the security compliance management system 100 monitors the stored security records of the facility for compliance with a security standard (e.g., CFATS). Based on the monitoring, the security compliance management system 100 displays a compliance indicator (FIG. 11 1108) and provides non-compliance notifications to security officials as described herein. The security compliance indicator 1108 denotes no current detected non-compliant conditions. If non-compliance is detected, the count value associated with the compliance indicator 1108 displays the number of non-compliant conditions detected and the color of the indicator 1108 denotes the severity of the non-compliance.

In block 912, the security compliance management system 100 receives a command or operation request from the user. The command may be provided via an input device 108, and may comprise, for example, clicking a button 1106 or a heading of the menu 1104, an underlying control feature, or entering a control value. Based on the command the security compliance management system 100 may:
display a security record using the display device 110 or other suitable display device in block 914,
enter security records via a dialog or upload in block 916,
edit security records (e.g., via dialog) in block 918,
search security records (via a search dialog) in block 920,
display a map depicting one or more facilities in block 922,
generate reports, or
perform other functions disclosed herein.

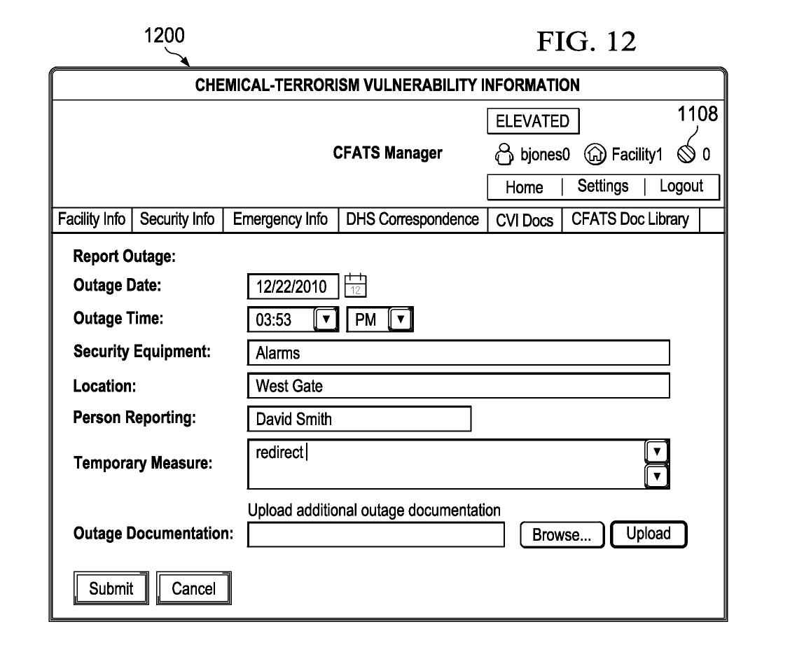

FIG. 12 shows an exemplary dialog 1200 generated by the security compliance management system 100 for entry of a security record, and more specifically, for entry of an equipment operability record. The dialog 1200 prompts for entry of equipment identification, outage time, mitigation measures, etc. Entry of an equipment outage using the dialog 1200 can result in the compliance monitoring module 304 detecting non-compliance with a security standard and indicating that the facility is non-compliant via the security compliance indicator 1108.

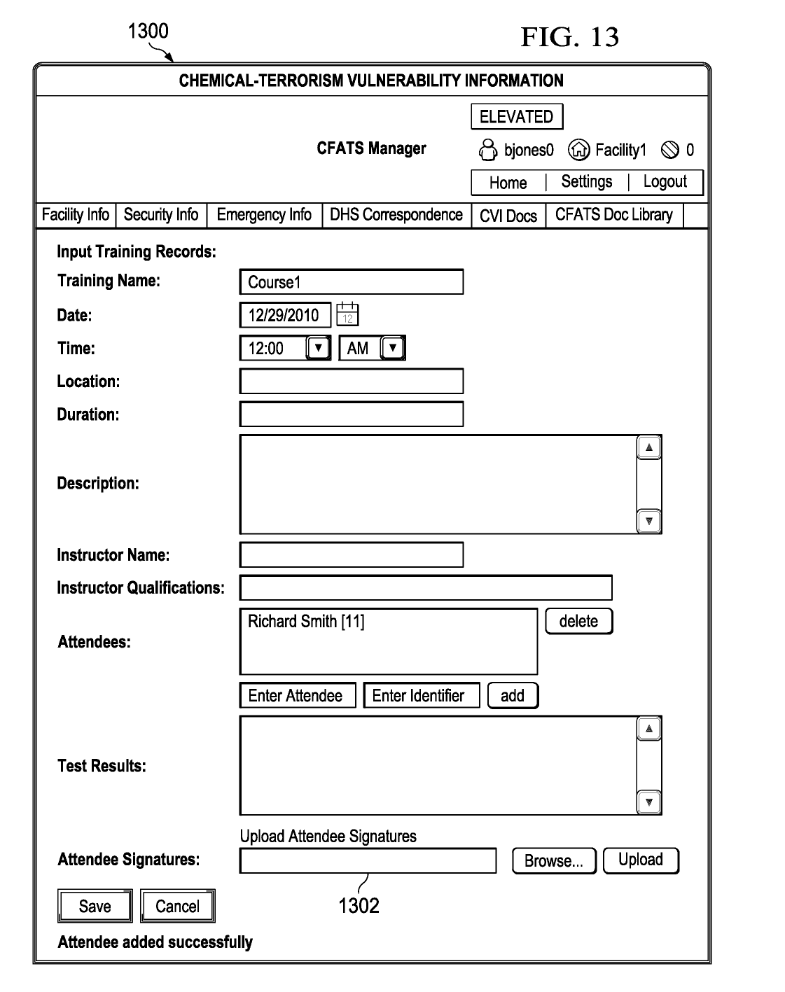

FIG. 13 shows an exemplary dialog 1300 generated by the security compliance management system 100 for entry of an employee training record. The dialog 1300 prompts for entry of training time, location, subject matter, etc. An employee signature may be required to authenticate the training information. Failure to include an employee's signature in the signature field 1302 can result in the compliance monitoring module 304 detecting non-compliance with a security standard and indicating that the facility is non-compliant via the security compliance indicator 1108.

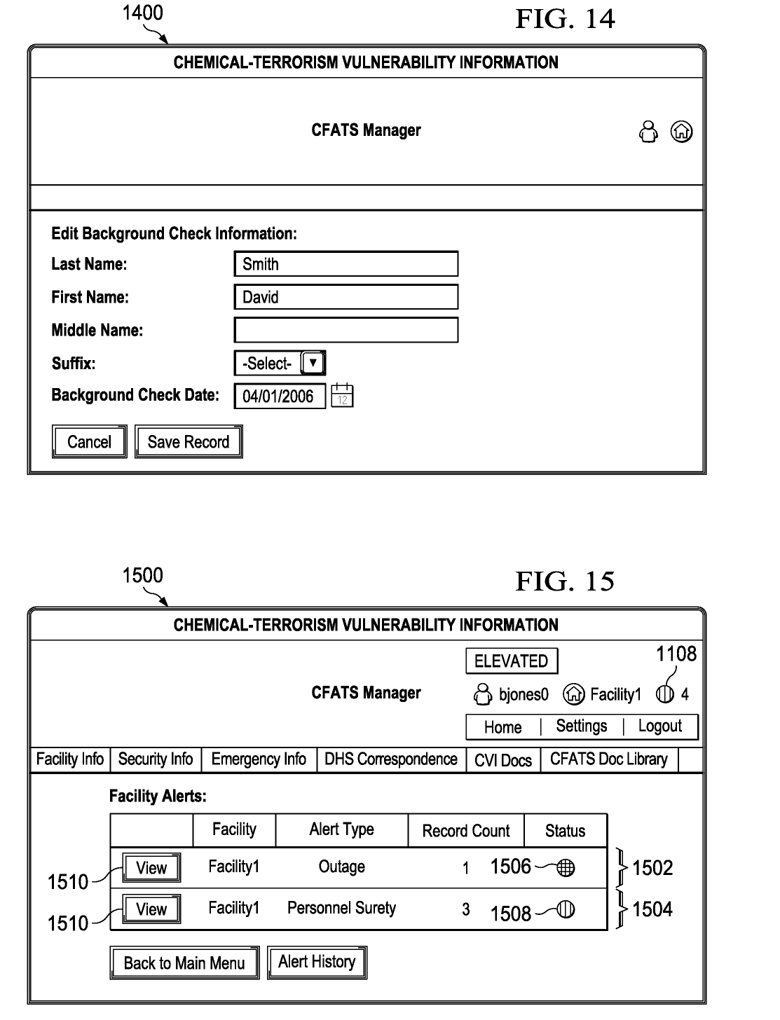

FIG. 14 shows an exemplary dialog 1400 generated by the security compliance management system 100 for entry of an employee background check record (i.e., a personnel surety record). The dialog 1400 prompts for entry of employee name and background check date. Other embodiments of the dialog 1400 may prompt for entry of additional information, such as date of birth, gender, passport number, citizenship, etc. Failure to undergo a background check by a prescribed date, as determined based on the date of a last background check, can result in the compliance monitoring module 304 detecting non-compliance with a security standard and indicating that the facility is non-compliant via the security compliance indicator 1108.

As explained above, the security compliance management system 100 notifies various security officers of a detected non-compliance with a security standard. The notification prompts the security officer to access the security compliance management system 100 for information regarding the non-compliant condition. The security compliance management system 100 provides information regarding detected non-compliant conditions via the Alerts button 1110 of dialog 1100. FIG. 15 shows a facility alerts dialog 1500 generated by the security compliance management system 100 that presents information regarding non-compliant conditions at a facility. For example, in dialog 1500, alert 1502 indicates that Facility1 is currently potentially non-compliant (indicator 1506) with the security standard due one instance of non-operational security equipment. Alert 1504 indicates that Facility1 is currently non-compliant (indicator 1508) with the security standard due three personnel surety (background check) violations. Additional information regarding the non-compliant conditions is provided via the view buttons 1510.

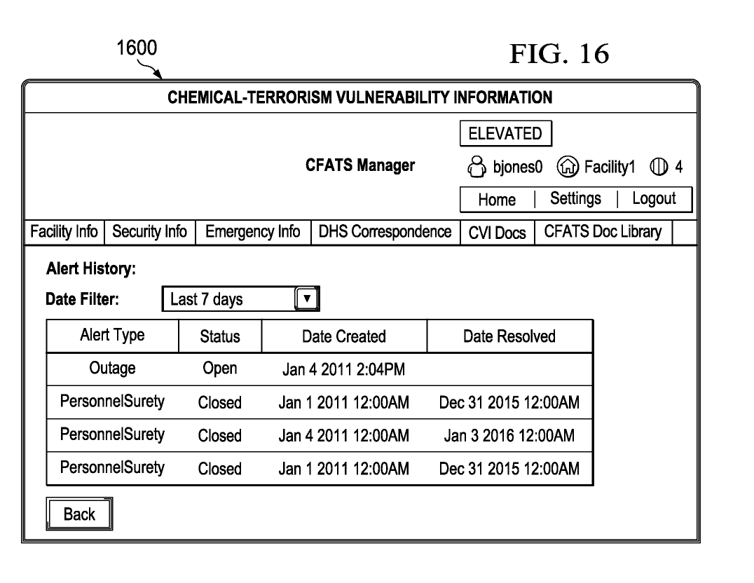

FIG. 16 shows an exemplary dialog 1600 generated by the security compliance management system 100 that presents information related to detected non-compliant conditions and selects non-compliant conditions for presentation based on the date at which the condition was detected. Some embodiments allow presentation based on alert type (operational status, security training overdue, etc.), alert status (condition corrected or uncorrected), date created (date condition detected), date resolved (date condition corrected), and/or other parameters. In FIG. 16, non-compliant conditions detected within the last seven days are displayed (three personnel surety and one equipment outage non-compliance conditions were detected). Embodiments may encompass any date range for display.

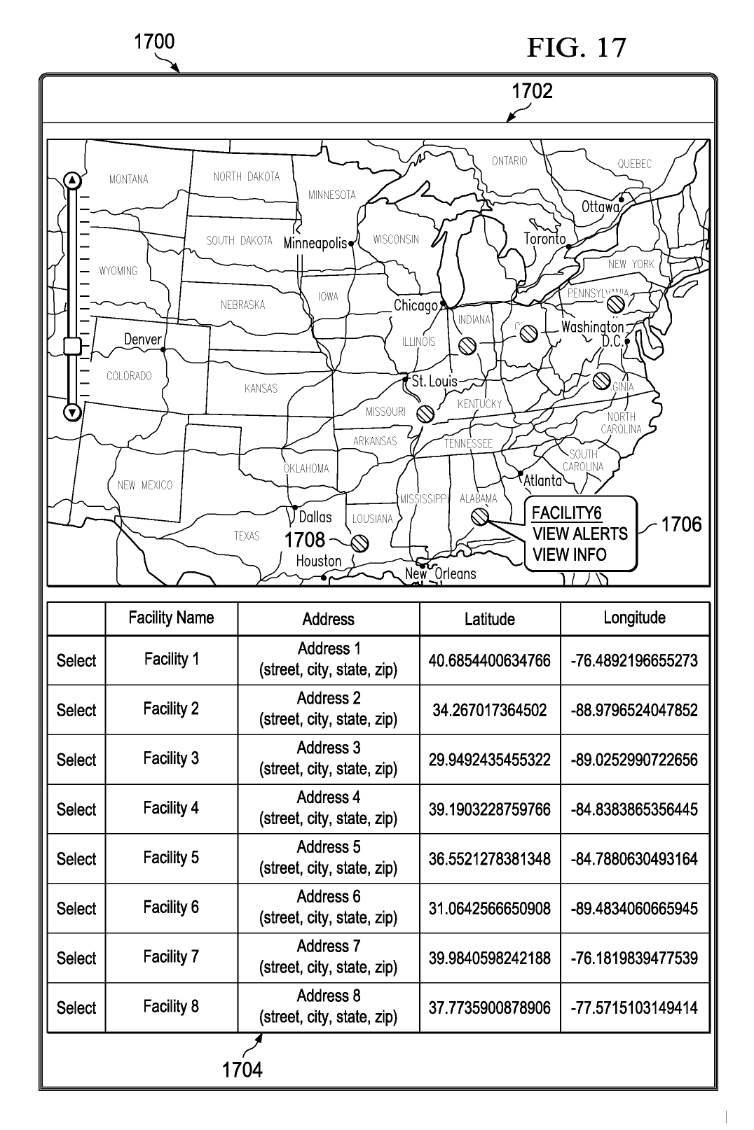

FIG. 17 shows an exemplary dialog 1700 generated by the security compliance management system 100 that includes a map 1702 showing a plurality of facilities controlled by an entity. Each facility is represented as a compliance indicator 1708 disposed on the map at the location of the facility. The compliance indicator 1708 is equivalent to the compliance indicator 1108 of FIG. 11, and displays facility compliance states equivalent to those displayed by the compliance indicator 1108. The security compliance management system 100 may restrict access to the dialog 1700 only to users assigned to a role that allows access to information pertaining to multiple facilities, for example a corporate security officer. Additional information regarding each facility may be obtained by selecting the facility from the facility list 1704, or, in some embodiments, by selecting (e.g., click on the compliance indicator 1702) or positioning a cursor over the compliance indicator 1702 as shown at 1706.

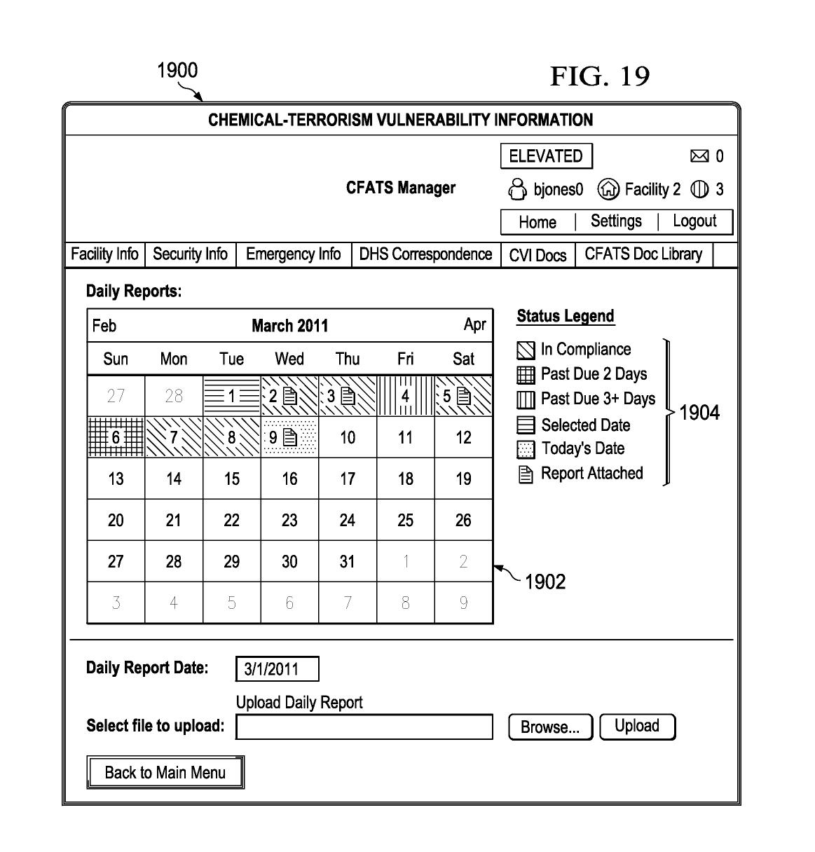

FIG. 19 shows an exemplary dialog 1900 generated by the security compliance management system 100 that allows entry of audit records and displays periodic audit record entry status 1902 where audit record entry is required on a daily basis. In this embodiment of the dialog 1900, each day for which an audit record is expected is assigned a compliance status 1904 based on whether the expected audit record has been entered and/or how long the expected record is overdue. In some embodiments, the compliance status may be further based on analysis by the auditing module 312 of whether the information contained in the entered audit record indicates that the facility is in compliance with the facility security plan.

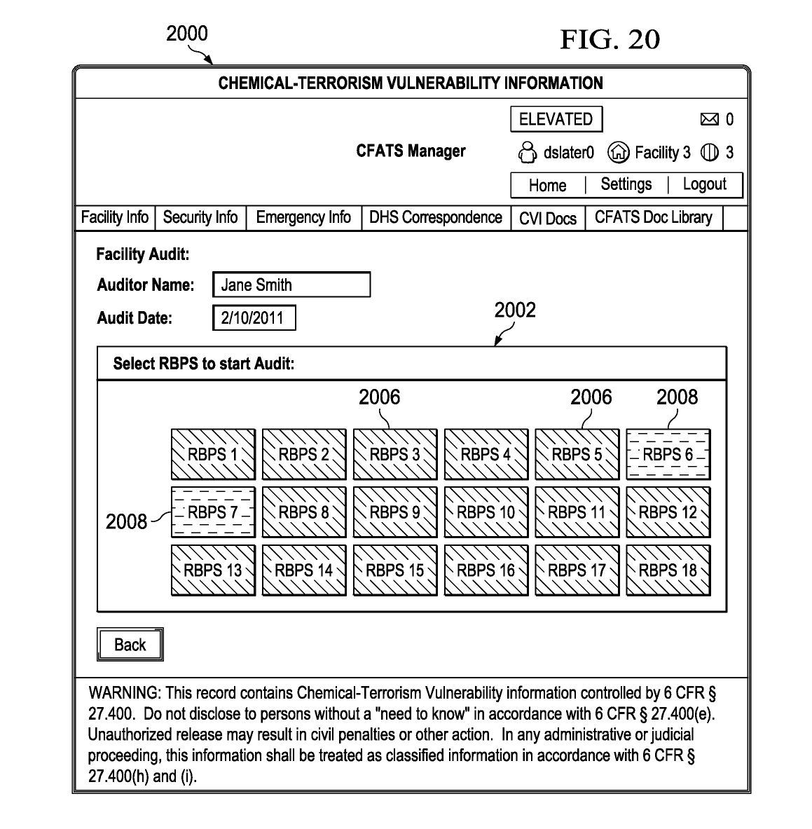

FIG. 20 shows an exemplary dialog 2000 generated by the security compliance management system 100 that allows selection of auditing questionnaires related security performance standards on which the facility security plan is based via buttons 2002. Some embodiments of the dialog 2000 provide an indicator associated with each standard based questionnaire denoting whether the questionnaire has been completed and/or is applicable to the facility. For example, in dialog 2000, standard-based questionnaires 2006 indicate completion (e.g., colored green), questionnaires 2008 are inapplicable to the facility (e.g., colored gray), and all other questionnaires are yet to be completed. When each questionnaire corresponding to a performance standard applicable to the facility is complete, the security compliance management system 100 generates an audit report include all the questions and answers, as well as daily audit records, and stored compliance records.

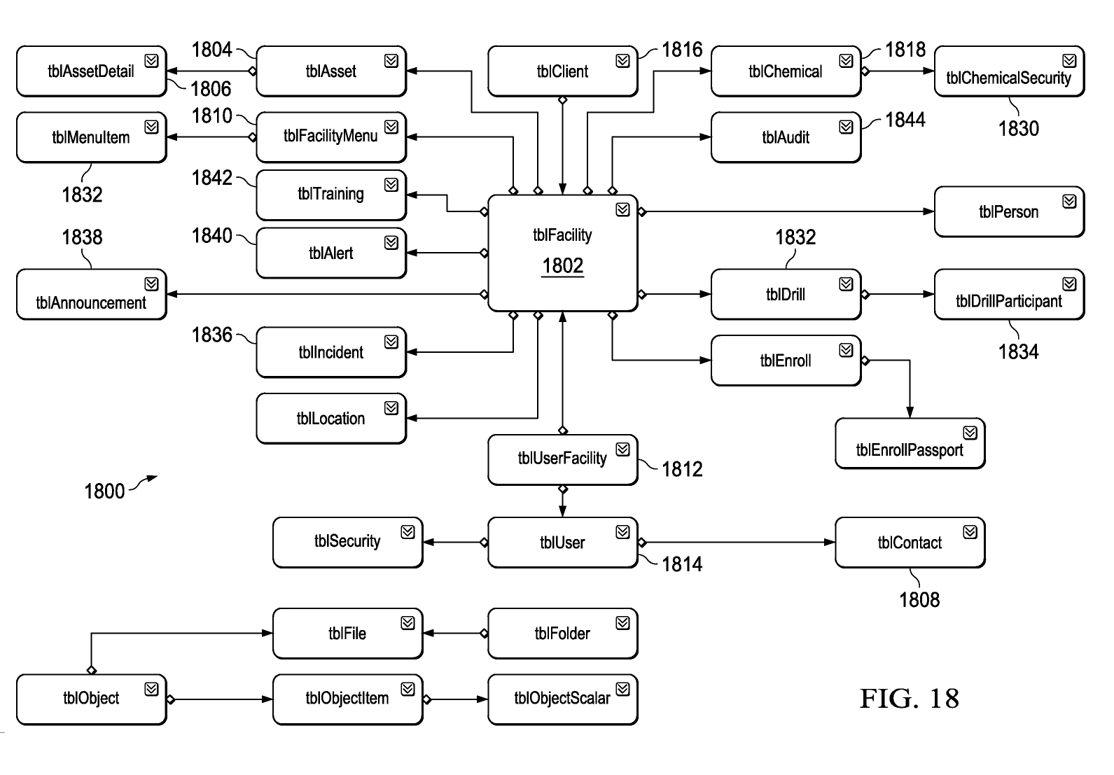

As mentioned above, the security compliance management system 100 may include a database for storage of the security records 116. FIG. 18 shows a security compliance management database 1800 of the security compliance management system 100 configured to store the security records 116. The database 1800 may be an object oriented database or a relational database, such as SQL SERVER by MICROSOFT Corporation. The security compliance management database 1800 is configured to generate a plurality of views comprising information extracted from the security records 116 stored in the database 1800. The security records 116 are organized by facility, and the records database 1800 is accordingly organized about a facility structure 1802. The facility structure 1802 includes items of information that identify a facility (e.g., facility name), the location of the facility (e.g., facility address), facility contact information (e.g., telephone number), chemical security assessment tool identifier (CSATID), etc.

The various security information structures related to the facility are linked to the facility structure 1802 in the database 1800. A client structure 1816 includes information identifying the client (e.g., the name of the entity controlling the facility) and contact information for the client. A chemical structure 1818 includes information regarding a chemical stored at the facility (e.g., a name of the chemical of interest). A chemical security structure 1830 includes information regarding security issues (e.g., volatility) relevant to the chemical identified in the chemical structure 1818.

A drill structure 1832 includes information regarding a security drill performed at the facility. Such information may include a time that the drill was conducted (e.g., date, duration, etc.), a location of the drill in the facility (e.g., west gate), a type of drill (e.g., perimeter incursion drill), etc. A drill participant structure 1834 linked to the drill structure 1832 includes information identifying an individual (e.g., name, role, etc.) taking part in the drill.

A user facility structure 1812 includes information (e.g., name, address, title, contact information, etc.) identifying personnel authorized to access the facility. A user structure 1814 linked to the user facility structure 1812 stores information identifying users of the security compliance management system 100. A contact structure 1808 stores information for communicating with each user of the facility and/or user of the security compliance management system 100.

An incident structure 1836 includes information related to security incidents occurring at the facility, threats against the facility, near misses (i.e., unsuccessful adversarial action against the facility), etc. Security incidents may include a range events that jeopardize security of the facility. For example, information regarding unauthorized personnel in the facility, perimeter breaches, attacks on the facility, tampering, etc. may be stored in the incident structure 1836.

An announcements structure 1838 includes information related to security messages provided to users of the security compliance management system 100 or the facility. Such information may include a time, content, source, and/or recipient of the statement.

An alert structure 1840 includes information related to detected conditions of the facility that are not compliant with a security standard. The information may include detection time, correction time, nature of the condition (equipment failure, expired training, etc), party reporting the condition, party correcting the condition, etc.

A training structure 1842 includes information related to employee education and training with regard to facility security. The information may include employee identification, nature of training provided, time of training, etc.

A facility menu structure 1810 includes information to be provided in facility specific menus of dialogs presented by the security compliance management system 100. The information includes menu headings. A menu item structure 1832 is linked to the menu structure 1810. The menu item structure 1832 includes information controlling the operation and display of a menu option or heading.

An asset structure 1804 includes information regarding structures, systems, processes, etc, (i.e., assets) that support storage, handling, security, etc. of chemicals within the facility. Such information may identify a location of an asset within the facility, and a chemical to which the asset is related. An asset detail structure 1806 is linked to the asset structure 1804. The asset detail structure 1806 includes information regarding security issues related to the asset (e.g., vulnerabilities) and asset specific security measures.

An audits structure 1844 includes information regarding examinations (i.e. audits) of facility compliance with a security standard and related policies and procedures. The information may include time of audit, specific assets or portions of the facility audited, standard applied, audit results, corrective measures, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A security compliance management system, comprising:
a processor;
a security documentation storage system coupled to the processor; and
a security compliance monitoring module that configures the processor to:
examine security records stored in the security documentation storage system;
identify compliance fields of the security records, the compliance fields containing information related to compliance of a facility with a security standard to which the facility is subject;
compare the information to predetermined values indicative of compliance with the security standard; and
generate an indicator signifying whether the facility is compliant with the security standard, wherein a state of the indicator is based on the comparison of the information to the predetermined values.

2. The security compliance management system of claim 1, further comprising:
a display device;
wherein the security compliance monitoring module configures the processor to generate the indicator as a graphic on the display device.

3. The security compliance management system of claim 1, wherein the indicator comprises a first alert indication based on the comparison detecting non-compliance with the security standard.

4. The security compliance management system of claim 3, wherein the security compliance monitoring module configures the processor to issue to a first level security official correspondence notifying the first level security official that the security compliance management system has detected non-compliance with the security standard.

5. The security compliance management system of claim 3, wherein the indicator comprises a second alert indication based on the detected non-compliance not being corrected within a predetermined time interval, wherein the second alert is indicative of a higher state of urgency than the first alert.

6. The security compliance management system of claim 5, wherein the security compliance monitoring module configures the processor to issue correspondence, based on the second alert, to a second level security official notifying the second level security official that the security compliance management system has detected non-compliance with the security standard; wherein the second level security official has authority over a first level security official that is previously notified of the non-compliance.

7. The security compliance management system of claim 6, wherein the first level security official is responsible for security of the facility, and the second level security official is responsible for security of an entity that controls the facility.

8. The security compliance management system of claim 1, wherein:
the security records comprise an employee background check record;
the employee background check record comprises a background check date field; and
the security compliance monitoring module configures the processor to:
identify the employee background check record and the background check date field;
extract a last check date value that a last employee background check was performed from the background check date field;
compare the last check date value to a predetermined date value by which a next employee background check must be performed to be compliant with the security standard; and
generate the indicator with a state signifying non-compliance with the security standard based on the last check date value indicating a later date than the predetermined date value.

9. The security compliance management system of claim 1, wherein:
the security records comprise an employee security training record;
the employee security training record comprises a security training date field; and
the security compliance monitoring module configures the processor to:
identify the employee security training record and the security training date field;
extract a last training date value that a last employee security training was performed from the security training date field; and
compare the last training date to a predetermined date value by which a next employee security training must be performed to be compliant with the security standard; and
generate the indicator with a state signifying non-compliance with the security standard based on the last training date value indicating a later date than the predetermined date value

10. The security compliance management system of claim 1, wherein:
the security records comprise a security equipment operability record;
the security equipment operability record comprises an equipment operability state field; and
the security compliance monitoring module configures the processor to:
identify the security equipment operability record and the equipment operability state field;
extract equipment operability state information from the security equipment operability field;
compare the equipment operability state information to an operability state value that the equipment must be in to be compliant with the security standard; and
generate the indicator with a state signifying non-compliance with the security standard based on the operability state information indicating a operability state other than the operability state value.

11. The security compliance management system of claim 1, wherein:
the security records include a record comprising an employee authentication field; and
the security compliance monitoring module configures the processor to:
identify the employee authentication field;
extract employee authentication information from the employee authentication field;
determine whether the employee authentication information comprises a signature value; wherein the employee authentication field must contain a signature value to be compliant with the security standard; and
generate the indicator with a state signifying non-compliance with the security standard based on the employee authentication information being determined to not include a signature value.

12. The security compliance management system of claim 1, wherein the indicator comprises a compliance state based on all security records stored in the security documentation storage system indicating compliance with the security standard.

13. The security compliance management system of claim 1, wherein the facility is a chemical repository and the security standard is an anti-terrorism regulation.

14. A method for managing security compliance of a facility, comprising:
storing security records related to the facility in a security documentation storage system;
identifying, by a processor, compliance fields of the security records, the compliance fields containing information related to compliance with a security standard applied to the facility;
comparing, by the processor, the information to predetermined values indicative of compliance with the security standard; and
generating, by the processor, an indicator signifying whether the facility is in compliance with the security standard; wherein a state of the indicator is based on a result of the comparing.

15. The method of claim 14, wherein generating the indicator comprises rendering the indicator as a graphic on a display device.

16. The method of claim 14, wherein generating the indicator comprises generating a first alert indication signifying that the comparing has detected non-compliance with the security standard.

17. The method of claim 16, further comprising issuing, to a first level security official, correspondence notifying the official to access a security compliance management system for information regarding the detected non-compliance.

18. The method of claim 16, further comprising providing a second alert indication based on the detected non-compliance not being corrected within a predetermined time interval after the first alert indication is generated, wherein the second alert indication signifies a higher level of non-compliance than the first alert indication.

19. The method of claim 16, further comprising issuing, to a second level security official, correspondence, based on the second alert, notifying the second level security official to access the security compliance management system for information regarding the detected non-compliance; wherein the second level security official has authority over a first level security official that is notified when the first alert indication is generated.

20. The method of claim 19, wherein the first level security official is responsible for security of the facility, and the second level security official is responsible for security of an entity that controls the facility.

21. The method of claim 14, wherein:
one of the security records is a record of employee background check;
the identifying comprising identifying a background check date field of the record of employee background check;
the information is a last check date that a last employee background check was performed;
the predetermined values comprise a date by which a next employee background check must be performed to be compliant with the security standard;
the comparing comprises comparing the last check date to the predetermined values; and
the generating comprises generating the indicator with a state signifying non-compliance with the security standard based on the last check date being later than the date by which a next employee background check must be performed.

22. The method of claim 14, wherein:
one of the security records is a record of employee security training;
the identifying comprising identifying a security training date field of the record of employee security training;
the information is a last training date that last employee security training was performed;
the predetermined values comprise a date by which a next employee security training must be performed to be compliant with the security standard;
the comparing comprises comparing the last training date to the predetermined values; and
the generating comprises generating the indicator with a state signifying non-compliance with the security standard based on the last training date being later than the date by which a next employee security training must be performed.

23. The method of claim 14, wherein:
one of the security records is a record of security equipment operability;
the identifying comprises identifying an operability state field of the record of security equipment operability;
the information is security equipment current operability state information;
the predetermined values comprise a minimum operability state required of the equipment to be compliant with the security standard;
the comparing comprises comparing the current operability state information to the minimum operability state; and
the generating comprises generating the indicator with a state signifying non-compliance with the security standard based on the current operability state information indicating an equipment operability state lower than the minimum operability state.

24. The method of claim 14, wherein:
one of the security records comprises an employee authentication field;
the identifying comprises identifying the employee authentication field;
the information is an employee signature;
the predetermined values comprise a signature value that the employee authentication field must contain to be compliant with the security standard;
the comparing comprises comparing the employee signature to the signature value; and
the generating comprises generating the indicator with a state signifying non-compliance with the security standard based on the employee signature not being the signature value.

25. The method of claim 18, wherein the security compliance monitoring module configures the processor to provide a third alert indication based on all security records stored in the security documentation storage system indicating compliance with the security standard.

26. The method of claim 14, wherein the facility is a chemical repository and the security standard is an anti-terrorism regulation.

27. A non-transitory computer-readable medium encoded with instructions that when executed cause a processor to:
examine security records stored in a security documentation storage system;
identify compliance fields of the security records, the compliance fields containing information related to compliance of a chemical facility with a security standard to which the facility is subject;
compare the information to predetermined values indicative of compliance with the security standard; and
generate an indicator signifying whether the facility is in compliance with the security standard, wherein a state of the indicator is based on the comparison of the information to the predetermined values.

28. The computer-readable medium of claim 27 encoded with instructions that when executed cause the processor to generate the indicator as a graphic on a display device.

29. The computer-readable medium of claim 27 encoded with instructions that when executed cause the processor to generate a first alert indication a part of the indicator, the first alert indication signifying that the comparison detected non-compliance with the security standard.

30. The computer-readable medium of claim 29 encoded with instructions that when executed cause the processor to issue to a first level security official correspondence notifying the official to access the security compliance management system for information regarding the detected non-compliance.

31. The computer-readable medium of claim 29 encoded with instructions that when executed cause the processor to generate a second alert indication as part of the indicator, the second alert indication based on the detected non-compliance not being corrected within a predetermined time interval, wherein the second alert indication denotes a higher state of urgency than the first alert indication.

32. The computer-readable medium of claim 31 encoded with instructions that when executed cause the processor to issue correspondence, based on the second alert, to a second level security official notifying the second level security official to access a security compliance management system for information regarding the detected non-compliance; wherein the second level security official has authority over a first level security official that is notified in conjunction with generation of the first alert indication.

33. The computer-readable medium of claim 27 encoded with instructions that when executed cause the processor to:
identify an employee background check record of the security records;
identify a background check date field of the employee background check record;
extract a date that a previous employee background check was performed from the background check date field; and
compare the date to a predetermined date value by which a next employee background check must be performed to be compliant with the security standard.

34. The computer-readable medium of claim 27 encoded with instructions that when executed cause the processor to:
identify an employee security training record of the security records;
identify a security training date field of the employee security training record;
extract a date that previous employee security training was performed from the security training date field; and
compare the date to a predetermined date value by which a next employee security training must be performed to be compliant with the security standard.

35. The computer-readable medium of claim 27 encoded with instructions that when executed cause the processor to:
identify a security equipment operability record of the security records;
identify an equipment operability state field of the security equipment operability record;
extract equipment operability state information from the security equipment operability field; and
compare the equipment operability state information to a minimum operability state value required of the equipment to be compliant with the security standard.

36. The computer-readable medium of claim 27 encoded with instructions that when executed cause the processor to:
identify an employee authentication field of a security record;
extract employee authentication information from the employee authentication field;
determine whether the employee authentication information comprises a signature value; wherein the employee authentication field must contain a signature value to be compliant with the security standard.

37. The computer-readable medium of claim 27 encoded with instructions that when executed cause the processor to generate a compliance indication as part of the indicator, the compliance indication based on all security records stored in the security documentation storage system indicating compliance with the security standard.

38. The computer-readable medium of claim 27 encoded with instructions that when executed cause the processor to apply a chemical anti-terrorism regulation as the security standard.

39. A non-transitory computer-readable medium encoded with instructions, that when executed cause a processor to:
receive an audit record containing information indicating whether a facility is compliant with a security plan applicable to the facility; and
notify a security official associated with the facility based on the audit record not be received by a first deadline.

40. The computer-readable medium of claim 39 encoded with instructions that when executed cause the processor to:
generate a first indication of the audit record being overdue based on the audit record not being received by a second deadline;
generate a second indication of the audit record being overdue based on the audit record not being received by a third deadline;
wherein the second deadline is subsequent to the first deadline and the third deadline is subsequent to the second deadline.

41. The computer-readable medium of claim 39 encoded with instructions that when executed cause the processor to:
expect an audit record to be received at a predetermined periodic interval;
generate a display showing status of audit records received over a plurality of the intervals.

42. The computer-readable medium of claim 39 encoded with instructions that when executed cause the processor to:
analyze the information contained in the audit record;
determine, based on the analysis, whether the facility is compliant with the security plan; and
notify the security official based on the facility being determined to be non-compliant with the security plan.

43. The computer-readable medium of claim 39 encoded with instructions that when executed cause the processor to:
display a questionnaire;
receive an answer to each question of the questionnaire;
wherein each question of the questionnaire is based on a level of risk assigned to the facility and a security performance standard applicable to the facility.

44. The computer-readable medium of claim 43 encoded with instructions that when executed cause the processor to:
generate an audit report indicating whether the facility is compliant with a security standard, the audit report comprising:
each question of the questionnaire and each received answer to each question;
a plurality of received periodic audit records, each audit record containing information indicating whether a facility is compliant with the security plan at a time corresponding to the audit record;
a plurality of security compliance records indicating whether the facility is compliant with a record-keeping requirement of the security standard.

45. A security compliance management system, comprising:
a processor;
a security management software system executable by the processor to manage compliance of a facility with a security standard; and
a security management database coupled to the processor and configured to store security records related to the facility for access by the processor;
wherein the security management database comprises:
a facility structure configured to contain information identifying a facility being managed for compliance with the security standard by the security compliance management system; and
a chemical structure, linked to the facility structure, configured to contain information identifying a chemical regulated under the security standard and located at the facility.

46. A security compliance management system of claim 45, further comprising a training structure, linked to the facility structure, configured to contain information indicating whether users of the facility have received training in accordance with the security standard.

47. A security compliance management system of claim 45, further comprising an asset structure, linked to the facility structure, configured to contain information identifying a resource of the facility subject to the security standard based on a chemical located at the facility and related to the resource.

48. A security compliance management system of claim 45, further comprising an alert structure, linked to the facility structure, configured to contain information identifying detected conditions indicative of the facility being non-compliant with the security standard.
